(19) United States
(12) Patent Application Publication
(10) Pub. No.: US 2026/0152868 A1
(43) Pub. Date: Jun. 4, 2026

(54) LITHIUM RECOVERY APPARATUS

(71) Applicants: POSCO Holdings Inc., Seoul (KR); RESEARCH INSTITUTE OF INDUSTRIAL SCIENCE & TECHNOLOGY, Pohang-si, Gyeongsangbuk-do (KR)

(72) Inventors: Kwang Soo PARK, Seoul (KR); Young Geun SON, Seoul (KR); Jae Sin PARK, Seoul (KR); Im-Gyu YEO, Seoul (KR); Byoung Ju KIM, Seoul (KR); Han Seok SEO, Seoul (KR)

(73) Assignees: POSCO Holdings Inc., Seoul (KR); RESEARCH INSTITUTE OF INDUSTRIAL SCIENCE & TECHNOLOGY, Pohang-si, Gyeongsangbuk-do (KR)

(21) Appl. No.: 19/125,523

(22) PCT Filed: Sep. 26, 2023
(86) PCT No.: PCT/KR2023/014920

§ 371 Date: Apr. 29, 2025

(30) Foreign Application Priority Data
Oct. 31, 2022 (KR) 10-2022-0142374

(51) Int. Cl. C25C 5/00; C25C 7/02; C25C 7/08

(52) U.S. Cl. CPC C25C 5/00; C25C 7/02; C25C 7/08

(57) ABSTRACT

The lithium recovery device according to an embodiment comprises:
the recovery body that provides an internal path through which gaseous lithium sulfide passes; the plurality of first electrodes installed in the recovery body and positioned spaced apart from each other; the plurality of second electrodes installed in the recovery body and alternately arranged with the plurality of first electrodes; and the voltage applying unit connected to the plurality of first electrodes and the plurality of second electrodes to apply voltage, wherein an electric field is generated between the plurality of first electrodes and the plurality of second electrodes by the voltage applied from the voltage applying unit, thereby collecting the gaseous lithium sulfide as lithium powder.

### TECHNICAL FIELD OF THE INVENTION

The present invention relates to a lithium recovery device, and more particularly, to a lithium recovery device for recovering gaseous lithium sulfide.

### BACKGROUND OF THE INVENTION

Generally, since lithium-ion batteries use a liquid electrolyte, they are prone to fire hazards and are not easy to store. To address these issues associated with lithium-ion batteries, all-solid-state batteries utilizing solid electrolytes are being developed.

Lithium sulfide (Li₂S) is being used as the solid electrolyte in these all-solid-state batteries.

Lithium recovery devices used for producing such lithium sulfide generally collect lithium powder through processes such as evaporation, condensation, and sublimation. That is, lithium sulfide may be collected by evaporating it along with gas and capturing it using a filter, by condensing it through a temperature difference, or by sublimating it and capturing it using a filter.

However, in this case, not only small and lightweight particles such as lithium powder but also larger particles are collected together, thereby requiring an additional post-process to separate only the small lithium powder.

Therefore, the lithium recovery process becomes more complicated, resulting in an increase in the size of the lithium recovery device and a decrease in the collection efficiency of lithium powder.

### SUMMARY OF THE INVENTION

The present invention provides a lithium recovery device that simplifies the lithium recovery process, thereby allowing for a compact device size and improving the collection efficiency of lithium sulfide powder.

The lithium recovery device according to an embodiment comprises: a recovery body that provides an internal path through which gaseous lithium sulfide passes; a plurality of first electrodes installed within the recovery body and positioned at intervals from each other; a plurality of second electrodes installed within the recovery body and alternately arranged with the plurality of first electrodes; and a voltage applying unit connected to the plurality of first electrodes and the plurality of second electrodes to apply voltage.

The voltage applied by the voltage applying unit generates an electric field between the plurality of first electrodes and the plurality of second electrodes, thereby collecting gaseous sulfide lithium as lithium powder.

The first electrode and the second electrode may partially overlap each other.

The recovery body further comprises a fixing member installed therein to secure the plurality of first electrodes and the plurality of second electrodes.

The fixing member comprises a first fixing member installed on one hemisphere of the recovery body and a second fixing member installed on the opposite hemisphere of the recovery body.

The plurality of first electrodes may be coupled to the first fixing member, and the plurality of second electrodes may be coupled to the second fixing member.

The first electrode and the second electrode may have a plate shape with a cutout or a groove.

The first electrode and the second electrode may have a mesh shape.

The device further comprises a powder separation unit that separates the lithium powder collected on the first electrode and the second electrode.

The powder separation unit may comprise a first powder separation unit that applies vibration to the first electrode and the second electrode to separate the lithium powder, and a second powder separation unit that applies a physical force to the surface of the first electrode and the second electrode to separate the lithium powder.

The first powder separation unit may comprise a vibration unit installed in the recovery body.

The second powder separation unit may comprise an electrode rotation unit connected to the first electrode and the second electrode to rotate them, and a wiper that contacts the surface of the first electrode and the second electrode as they rotate, thereby separating the lithium powder from the first electrode and the second electrode.

The voltage applying unit may apply a reverse voltage to the first electrode and the second electrode to separate the lithium powder from the first electrode and the second electrode.

The lithium recovery device according to an embodiment may selectively collect small-sized lithium powder by utilizing the electric field generated between the plurality of first electrodes and the plurality of second electrodes to capture gaseous lithium sulfide as lithium powder.

Therefore, the collection efficiency of lithium powder can be improved.

Additionally, since only lithium powder is selectively collected, no separate post-processing is required, allowing the lithium recovery device to be compact in size and reducing lithium recovery costs.

### BRIEF DESCRIPTION OF THE DRAWINGS

FIG. 1 is an exploded perspective view of a lithium recovery device according to an embodiment.

FIG. 2 is a cross-sectional view of FIG. 1.

FIG. 3 is a top plan view of a first electrode or a second electrode of a lithium recovery device according to an embodiment.

FIG. 4 is a drawing illustrating a state in which lithium powder is collected on the first electrode and the second electrode of FIG. 2.

FIG. 5 is a top plan view of a first electrode or a second electrode of a lithium recovery device according to another embodiment.

FIG. 6 is a top plan view of a first electrode or a second electrode of a lithium recovery device according to yet another embodiment of the present invention.

FIG. 7 is a cross-sectional view of a lithium recovery device according to another embodiment.

### DETAILED DESCRIPTION OF THE EMBODIMENTS

The present invention will be described more fully hereinafter with reference to the accompanying drawings, in which embodiments of the invention are shown. As those skilled in the art would realize, the described embodiments may be modified in various different ways, all without departing from the spirit or scope of the present invention.

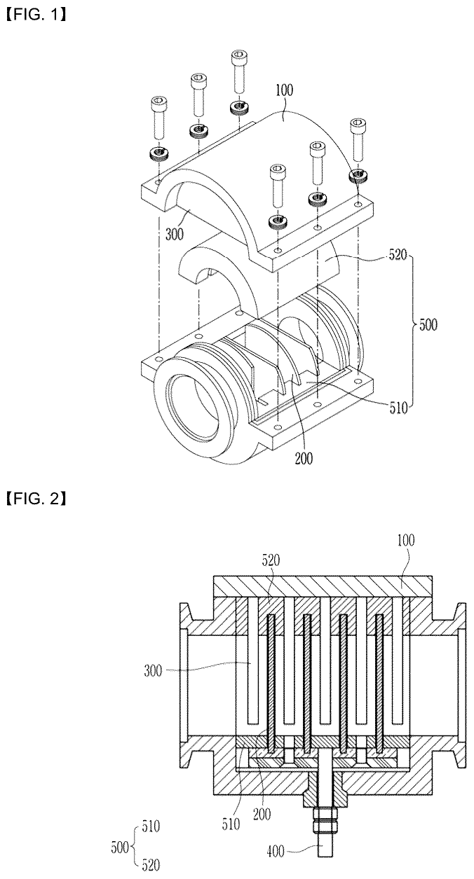

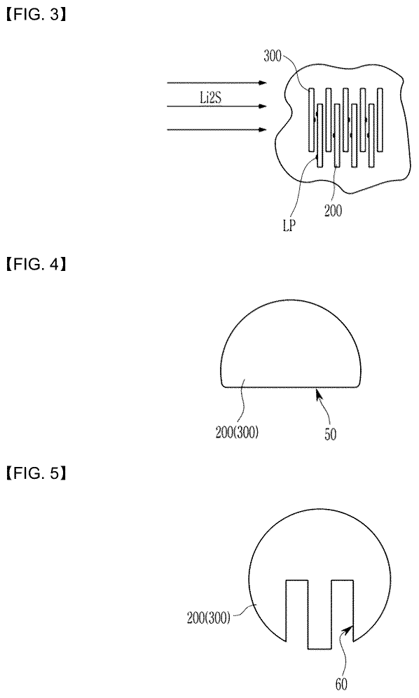

FIG. 1 is an exploded perspective view of a lithium recovery device according to an embodiment. FIG. 2 is a cross-sectional view of FIG. 1. FIG. 3 is a top plan view of a first electrode or a second electrode of a lithium recovery device according to an embodiment. FIG. 4 is a drawing illustrating a state in which lithium powder is collected on the first electrode and the second electrode of FIG. 2.

As shown in FIG. 1 and FIG. 2, a lithium recovery device according to an embodiment includes a recovery body 100, a plurality of first electrodes 200, a plurality of second electrodes 300, a voltage applying unit 400, and a fixing member 500.

The recovery body 100 may provide an internal path through which gaseous lithium sulfide (Li₂S) passes. In the present embodiment, the recovery body 100 is illustrated as having a hollow cylindrical shape, however, the invention is not limited thereto, and various shapes of the recovery body may be employed.

The plurality of first electrodes 200 may be installed within the recovery body 100 and positioned spaced apart from each other. As shown in FIG. 3, the first electrode 200 may have a circular plate shape with a cutout 50. Therefore, the contact area between the gaseous lithium sulfide (Li₂S) and the first electrode 200 can be increased, thereby improving the collection efficiency of lithium powder (LP).

However, the shape of the first electrode 200 is not limited thereto, and as shown in FIG. 5, the first electrode 200 may have a circular plate shape with a plurality of grooves 60. By forming the plurality of grooves 60 in the first electrode 200, the contact area between the gaseous lithium sulfide (Li₂S) and the first electrode 200 can be increased, thereby improving the collection efficiency of lithium powder (LP).

The plurality of second electrodes 300 may be installed within the recovery body 100 and may be alternately arranged with the plurality of first electrodes 200.

As shown in FIG. 3, the second electrode 300 may have a circular plate shape with a cutout 50. Therefore, the contact area between the gaseous lithium sulfide (Li₂S) and the second electrode 300 can be increased, thereby improving the collection efficiency of lithium powder (LP).

However, the shape of the second electrode 300 is not limited thereto, and as shown in FIG. 5, the second electrode 300 may have a circular plate shape with a plurality of grooves 60. By forming the plurality of grooves 60 in the second electrode 300, the contact area between the gaseous lithium sulfide (Li₂S) and the second electrode 300 can be increased, thereby improving the collection efficiency of lithium powder (LP).

The first electrode 200 and the second electrode 300 may partially overlap each other. Therefore, the internal path through which the gaseous lithium sulfide passes becomes a zigzag shape due to the partial overlap, resulting in an increased path length, which can improve the collection efficiency of lithium powder (LP).

The voltage applying unit 400 is connected to the plurality of first electrodes 200 and the plurality of second electrodes 300, and may apply a voltage of approximately 50 to 100V to the plurality of first electrodes 200 and the plurality of second electrodes 300. By the voltage applied to the plurality of first electrodes 200 and the plurality of second electrodes 300 through the voltage applying unit 400, an electric field is generated between the plurality of first electrodes 200 and the plurality of second electrodes 300, thereby enabling the collection of gaseous lithium sulfide as lithium powder.

As shown in FIG. 3, when the gaseous lithium sulfide carries a positive or negative charge, the ionized lithium sulfide may be attracted to and adhere to the plurality of first electrodes 200 and the plurality of second electrodes 300 by the electric field formed between them, and thereby be collected as lithium powder (LP).

The fixing member 500 may be installed within the recovery body 100 and may secure the plurality of first electrodes 200 and the plurality of second electrodes 300 in place. The fixing member 500 may be made of an insulating material such as TEFLON (tetrafluoroethylene).

The fixing member 500 may include a first fixing member 510 and a second fixing member 520. The first fixing member 510 may be installed on one hemisphere of the recovery body 100, namely, the lower hemisphere.

The plurality of first electrodes 200 may be coupled to the first fixing member 510. In this case, the cutouts 50 of the plurality of first electrodes 200 may be positioned in different directions and coupled to the first fixing member 510. Therefore, the internal path through which the gaseous lithium sulfide passes becomes longer, thereby improving the collection efficiency of lithium powder (LP).

The second fixing member 520 may be installed on the opposite hemisphere of the recovery body 100, namely, the upper hemisphere, which faces the one hemisphere. The plurality of second electrodes 300 may be coupled to the second fixing member 520.

In this case, the cutouts 50 of the plurality of second electrodes 300 may be positioned in different directions and coupled to the second fixing member 520. Therefore, the internal path through which the gaseous lithium sulfide passes becomes longer, thereby improving the collection efficiency of lithium powder (LP).

Meanwhile, unlike the previously described embodiment, another embodiment is also possible in which the first electrode and the second electrode have a mesh shape.

Hereinafter, referring to FIG. 6, the lithium recovery device according to another embodiment will be described in detail.

FIG. 6 is a top plan view of a first electrode or a second electrode of the lithium recovery device according to yet another embodiment of the present invention.

The embodiment shown in FIG. 6 is substantially the same as the embodiment illustrated in FIGS. 1 to 4, except for the structure of the first electrode and the second electrode, and thus repeated descriptions will be omitted.

As shown in FIG. 6, the lithium recovery device according to another embodiment includes the recovery body 100, a plurality of first electrodes 200, a plurality of second electrodes 300, a voltage applying unit 400, and a fixing member 500.

The first electrode 200 and the second electrode 300 may have a mesh shape. Therefore, the contact area between the gaseous lithium sulfide (Li₂S) and the first electrode 200 and the second electrode 300 can be increased, thereby enhancing the charging effect and improving the collection efficiency of lithium powder (LP).

Meanwhile, unlike the previously described embodiment, another embodiment is also possible in which a powder separation unit for separating lithium powder is installed.

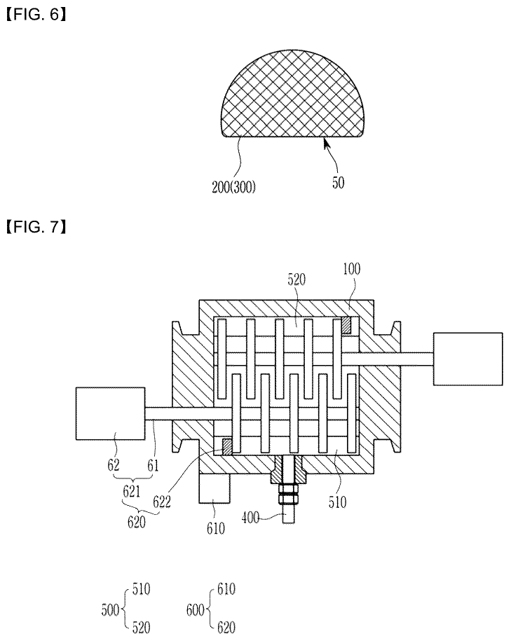

Hereinafter, referring to FIG. 7, a lithium recovery device according to another embodiment will be described in detail.

FIG. 7 is a cross-sectional view of a lithium recovery device according to yet another embodiment of the present invention.

The embodiment shown in FIG. 7 is substantially the same as the embodiment illustrated in FIGS. 1 to 4, except for the structure of the powder separation unit, and thus repeated descriptions will be omitted.

As shown in FIG. 7, the lithium recovery device according to another embodiment includes a recovery body 100, a plurality of first electrodes 200, a plurality of second electrodes 300, a voltage applying unit 400, a fixing member 500, and a powder separation unit 600.

The powder separation unit 600 may separate lithium powder collected on the first electrode 200 and the second electrode 300.

The powder separation unit 600 may include a first powder separation unit 610 and a second powder separation unit 620.

The first powder separation unit 610 may include a vibration unit 630 installed in the recovery body 100. The vibration unit 630 is a device for generating vibration and may include a vibration motor or the like. As such, the first powder separation unit 610 may apply vibration to the first electrode 200 and the second electrode 300 to separate lithium powder from the first electrode 200 and the second electrode 300.

The second powder separation unit 620 may include an electrode rotation unit 621 and a wiper 622.

The electrode rotation unit 621 is connected to the first electrode 200 and the second electrode 300 and may rotate the first electrode 200 and the second electrode 300. The electrode rotation unit 621 may include a rotation shaft 61 connected along the central axis of the first electrode 200 and the second electrode 300, and a rotation motor 62 connected to the rotation shaft 61 to rotate the rotation shaft 61.

The wiper 622 may contact the surface of the first electrode 200 and the second electrode rotated by the electrode rotation unit 621, and apply physical force to the first electrode 200 and the second electrode to separate lithium powder therefrom.

In addition, a reverse voltage to that applied for powder collection may be applied from the voltage applying unit to the first electrode 200 and the second electrode 300, so that lithium powder can be separated from the first electrode 200 and the second electrode 300 by an opposite charge effect.

While the present disclosure has been described through preferred embodiments as set forth above, it is not limited thereto, and it will be readily understood by those skilled in the art that various modifications and alterations can be made without departing from the scope of the claims set forth below.

[Description of Reference Numerals]

| | |
|---|---|
| 100: recovery body | 200: plurality of first electrode |
| 300: plurality of second electrode | 400: voltage applying unit |
| 500: fixing member | 600: powder separation unit |

What is claimed is:

1. A lithium recovery device, comprises:
a recovery body that provides an internal path through which gaseous lithium sulfide passes,
a plurality of first electrodes, installed within the recovery body and positioned at intervals from each other,
a plurality of second electrodes, installed within the recovery body and alternately arranged with the plurality of first electrodes, and
a voltage applying unit connected to the plurality of first electrodes and the plurality of second electrodes, applying voltage to them
wherein, an electric field is generated between the plurality of first electrodes and the plurality of second electrodes by applying voltage through the voltage applying unit, and thereby gaseous lithium sulfide is collected as lithium powder.

2. The lithium recovery device of claim 1, wherein:
the first electrodes and second electrodes partially overlap each other.

3. The lithium recovery device of claim 1,
the device further comprises a fixing member installed in the recovery body to secure the plurality of first electrodes and the plurality of second electrodes,
wherein, the fixing member comprises:
a first fixing member installed on one hemisphere of the recovery body, and
a second fixing member installed on the opposite hemisphere of the recovery body, facing the one hemisphere,
wherein, the plurality of first electrodes are coupled to the first fixing member, and
the plurality of second electrodes are coupled to the second fixing member in a lithium recovery apparatus.

4. The lithium recovery device of claim 1, wherein:
the first electrode and the second electrode have a plate shape with a cutout or a groove.

5. The lithium recovery device of claim 1, wherein:
the first electrode and the second electrode have a mesh shape.

6. The lithium recovery device of claim 1,
the device further comprises a powder separation unit that separates the lithium powder collected on the first electrode and the second electrode,
wherein, the powder separation unit comprises:
a first powder separation unit that applies vibration to the first electrode and the second electrode to separate the lithium powder, and
a second powder separation unit that applies physical force to the surface of the first electrode and the second electrode to separate the lithium powder.

7. The lithium recovery device of claim 6, wherein:
the first powder separation unit comprises a vibration unit installed in the recovery body.

8. The lithium recovery device of claim 6, wherein:
the second powder separation unit comprises:
an electrode rotation unit connected to the first electrode and the second electrode to rotate the first electrode and the second electrode; and
a wiper that contacts the surface of the first electrode and the second electrode rotated by the electrode rotation unit to separate lithium powder from the first electrode and the second electrode.

9. The lithium recovery device of claim 6, wherein:
the voltage applying unit applies a reverse voltage to the first electrode and the second electrode to separate lithium powder from the first electrode and the second electrode.
